(19) United States
(12) Patent Application Publication
(10) Pub. No.: US 2015/0042143 A1
(43) Pub. Date: Feb. 12, 2015

(54) HEAD SUPPORT

(71) Applicants: William T McCarter, Donegal (IE); Maria Francesca Maginness, Belfast (GB); Brian Alphonsus Maginness, Belfast (GB)

(72) Inventors: Joseph Gabriel Maginness, Belfast (GB); Maria Francesca Maginness, Belfast (GB)

(21) Appl. No.: 14/380,502

(22) PCT Filed: Feb. 22, 2013
(86) PCT No.: PCT/EP2013/053627

§ 371 Date: Aug. 22, 2014

(30) Foreign Application Priority Data
Feb. 22, 2012 (GB) 1203048.2

(51) Int. Cl. A47C 7/38; B64D 11/00

(52) U.S. Cl. CPC A47C 7/383; B64D 11/00
USPC 297/393

(57) ABSTRACT

Head support (10) for a person for use primarily during air travel, comprises a head piece (12) adapted to fit around the forehead of the person and a harness extending from the head piece to an anchor section which is connected to the person. The harness (14) includes one or more adjustable straps (16) so that the person can sleep in an upright seated position while supporting his or her head. The anchor section may be a portion of the harness (14) which passes under the person's upper thighs so that when the person is seated on the portion it provides an anchor for the head support (10).

The present invention relates to a head support and in particular to a light weight head support for use in confined spaces.

Due to increased volumes of national and International airline flights, a greater number of passengers spend an increasing number of hours travelling which generally involves sitting in confined spaces. These spaces are particularly uncomfortable if a passenger is required to rest in an upright sitting position for prolonged periods of time for example on a long haul flight in an economy class aeroplane seat. Passengers encounter problems with trying to sleep under these conditions and one problem occurs as a direct result of the weight of the passengers' heads. When a person starts to slip into a light sleep, the muscles of the neck relax and the head drops suddenly causing a small shock to the body of the passenger as a result of the jerking motion and the passengers' light sleep is broken. This cycle is repeated generally until the passenger finds a position where the weight of the head has at least partial support avoiding the jerking action of the head. The problem with this type of resting position is that the passenger often wakens up with a strain in their neck muscles.

It is an object of the present invention to obviate or mitigate the above outlined problem.

The present invention provides a head support for use primarily during air travel, the head support comprising a head piece adapted to fit around the forehead of the person and a harness extending from the head piece to an anchor section which is connectable to the person with the harness including one or more adjustable straps so that the person can sleep in an upright seated position while supporting his or her head.

Advantageously, the anchor section is a portion of the support which passes under the person's upper thighs so that when the person is seated on said portion it provides an anchor for the head support.

Alternatively, the anchor section comprises one or more clasps on the adjustable straps, the clasps being engageable with a belt, waistband or other support on the person's body.

Conveniently, the head piece is a head band.

Ideally, the harness and head band are adjustable by a pair of straps positionable behind the person in front of the backrest of a seat on which the person is seated, whereby the harness and adjustable straps are retained out of sight, with the head band around the person's forehead only being visible when viewed front on.

Conveniently, the head band may be worn under a cap so as to conceal the head band if required when viewed front on.

Ideally, the outer face of the head band may be provided with a printed message for promotional, advertising or branding purposes.

Advantageously, the inner face of the head band is provided with a cushioned or soft fabric band for the comfort of the user.

Conveniently, the harness and strap are adjustable by means of a plurality of buckles.

Ideally, a buckle is provided at the rear of the head band so that the size of the head band may be adjustable to suit the size of the person's head.

The head band may be tightened by the user to be a comfortable fit. Ideally, the head band is left loose with the head band buckle being located around the base of the person's head. The head band may also be adjustable in size by the use of Velcro straps.

Preferably, the head band, harness and adjustable straps are manufactured from a flexible strapping material.

Typically, the strapping material is plastics webbing of approximately 25 mm in width with a portion of the headband in contact with the user being wider for comfort.

The invention will hereinafter be more particularly described with reference to the accompanying drawings which show by way of example only, a number of embodiments of a head support according to the invention. In the drawings:

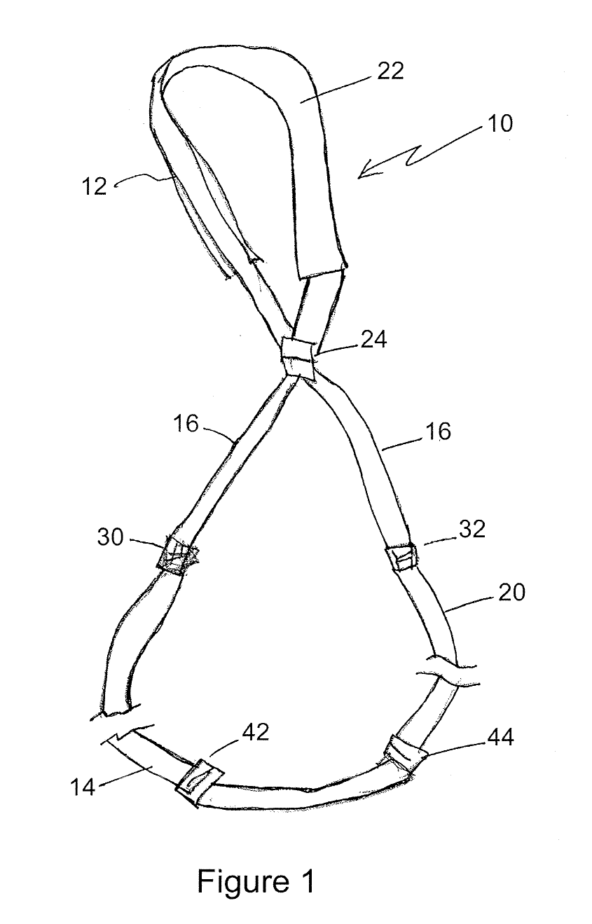

FIG. 1 is a pictorial view of a head support of a first embodiment of the invention;

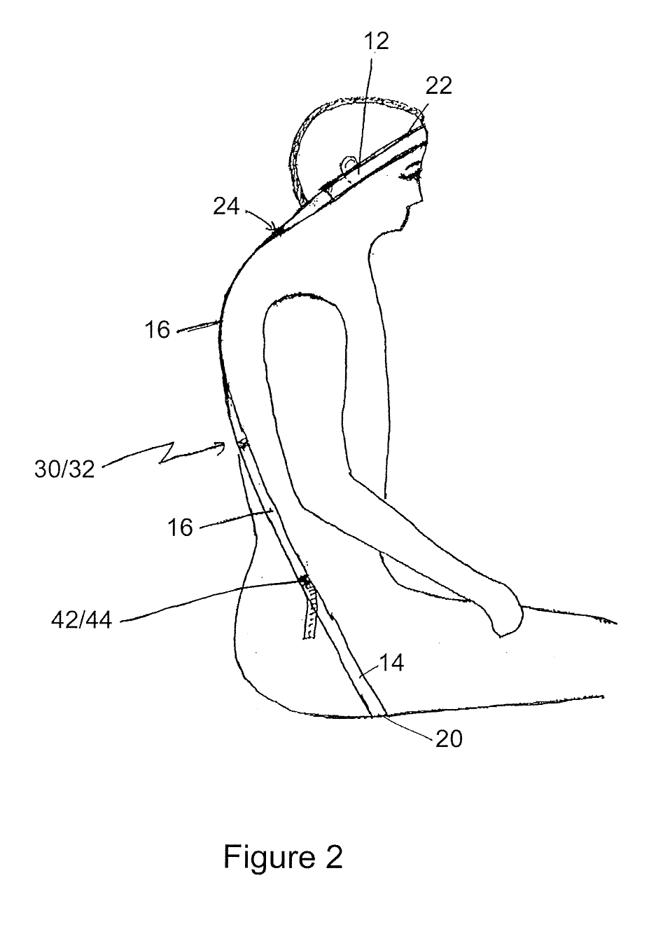

FIG. 2 is a side view of the head support of the first embodiment when worn by a user;

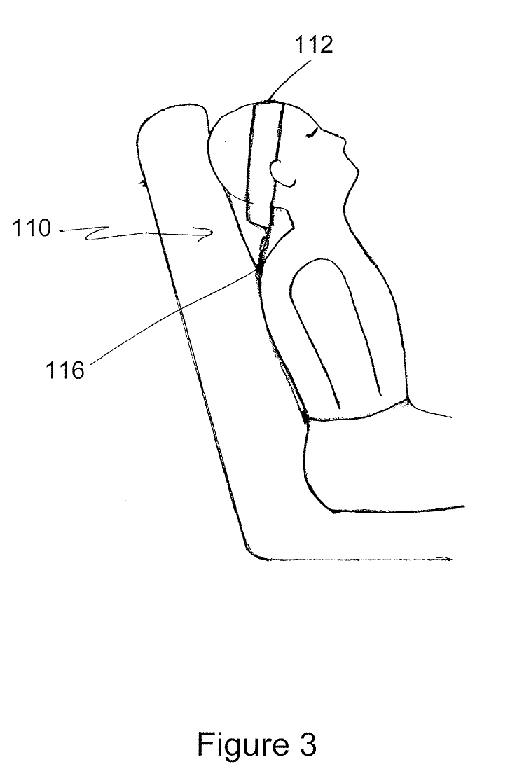

FIG. 3 is a side view of a head support of a second embodiment of the invention when worn by a user;

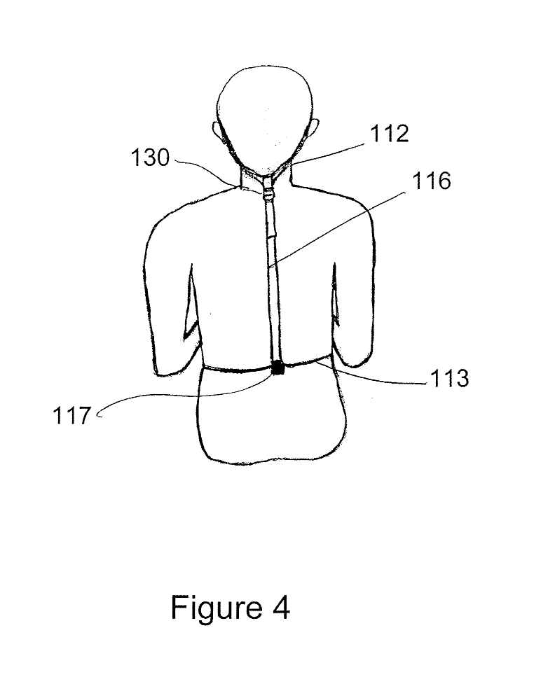

FIG. 4 is a rear view of the user wearing the head support of the second embodiment;

FIG. 5 is a truncated side view of the head support of the second embodiment showing the head band and harness;

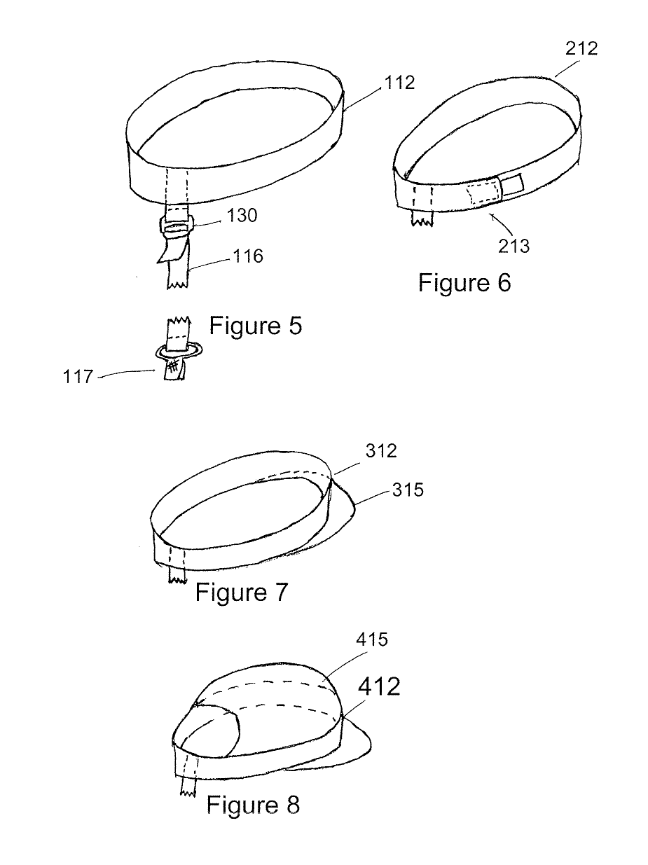

FIGS. 6, 7 and 8 are side views of various types of head band, namely an adjustable head band, a head band with a visor and a head band incorporated in a baseball type cap;

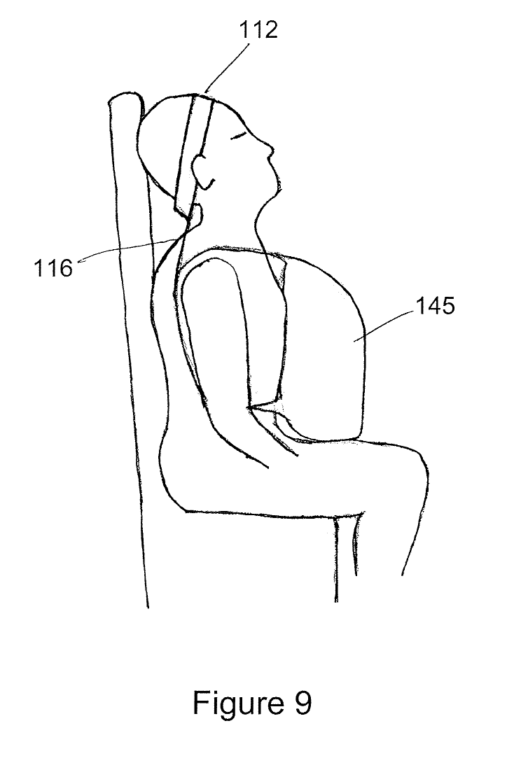

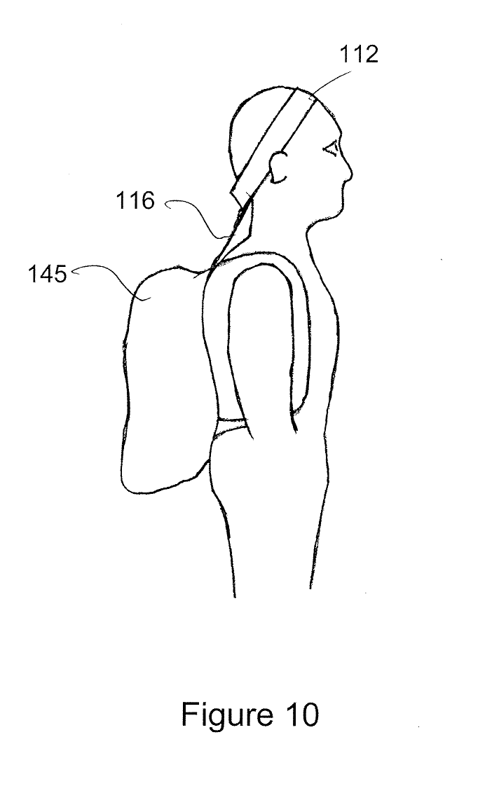

FIG. 9 shows a variation of the second embodiment anchored to a rucksack worn on the front of the user and FIG. 10 shows a further variation of the second embodiment anchored to a rucksack worn on the back of the user; and

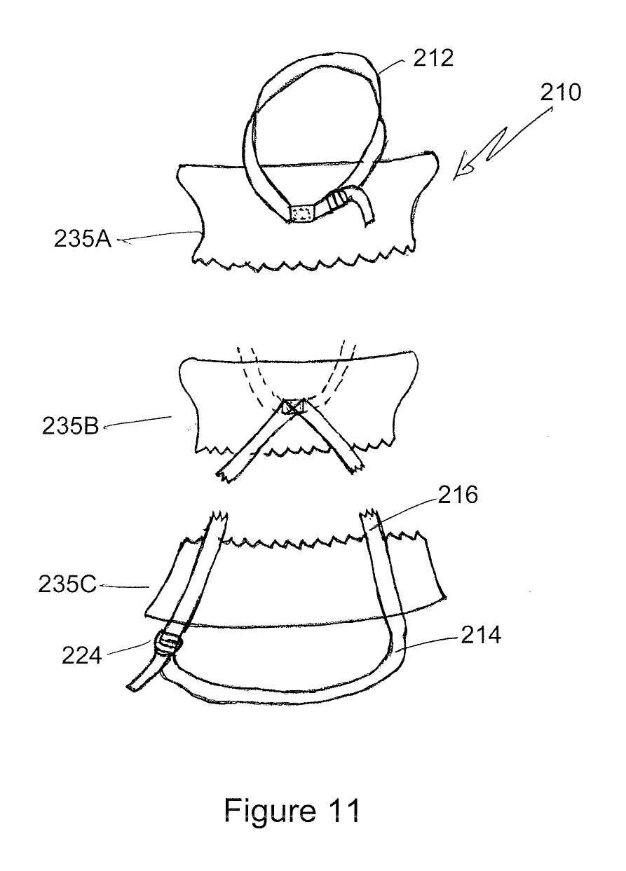

FIG. 11 is a truncated side view of a third embodiment of head support according to the invention.

Referring to the drawings and initially to FIGS. 1 and 2, head support 10 comprises a head band 12, a harness 14 and a pair of adjustable straps 16 generally formed from elongate flexible strapping 20 of a uniform width with a portion of the head band wider to provide extra comfort.

The head band 12 has a soft contact fabric 22 on the inside of the head band and wider than the head band 12. At the rear of the head band is a buckle 24 which can be used to adjust the circumference of the head band. A pair of adjustable straps 16 extend from the left hand side and the right hand side down to the harness 14. Each of the straps 16 can be adjusted by separate buckles 30, 32.

The harness 14 is a sufficient length to fit under a person's upper thighs and can be adjusted by buckles 42, 44 so as to be the correct length whereby when a person sits on the harness, the person's head is retained in an upright sitting posture. The extra lengths of straps 16 adjacent buckles 42, 44 are easier to adjust when the person is seated.

When the person is seated on the harness on an airline seat for example, the harness 14 is out of sight as are the adjustable straps 16 which can be located behind the person's back. The only visible part of the head support is then the front of the head band 12 when viewed front on.

Branding, promotional or advertising material may be printed or attached to the front of the head band 12.

If the user wishes to wear a cap or other headgear, the head band will fit inside the cap or headgear so as to conceal the head support while retaining the person's head to be held in a fixed position while allowing the user to sleep.

Also, a hat or cap can act as or replace the head band, i.e. the back straps 16 would be connected to the back of the hat or cap. The head band could also be built into the hat or cap.

Additionally, the harness 14 can be replaced by using the person's own waist belt to anchor the two back straps 16.

The second embodiment of the invention will now be described with reference to FIGS. 3 to 5 of the drawings.

Head support 110 comprises a head band 112, a single adjustable strap 116 which can be anchored to a person's waistband or belt 113 by a clip 117. The strap 116 is adjustable by means of a buckle 130 which can be located close to the headband 112 as shown or close to the clip 117. The head band 112 is a one size fits all and can be fitted on different sized heads by changing the angle at which it is worn. The head band 112 is made of a neoprene strip with non-stretch binding at its edges. Two trailing straps 116 can also be used.

In the FIG. 6 modification, the head band 212 is adjustable by having a Velcro strap 213 which can be opened to adjust the circumference of the head band.

The head band 312 shown in FIG. 7 is fitted with a sun visor 315 and the headband 412 shown in FIG. 8 is provided with a baseball type cap 415.

In FIG. 9 the head band 112 is shown worn by a user and with the strap or straps 116 secured to a knapsack 145 worn on the front of the user. In FIG. 10 the strap(s) 116 are secured to the knapsack 145 and the user may if he or she chooses, use the head band to bear some weight from the knapsack.

The third embodiment as shown in FIG. 11 is a head support 210, similar in general construction to the first embodiment except that it is incorporated into a coat 235, portions A, B and C of which are shown. The head support 210 includes a head band 212, a harness 214 including adjustable straps 216 with one or more buckles 224, all of which are concealed within the lining of the jacket. The head band 212 and the harness 214 can be folded up and stored in suitable pockets or seams of the coat.

It is to be understood that the invention is not limited to the specific details described herein, which are given by way of example only, and that various modifications and alterations are possible without departing from the scope of the invention as defined in the appended claims.

1. A head support for a person for use primarily during air travel, the head support comprising a head piece adapted to fit around the forehead of the person and a harness extending from the head piece to an anchor section which is connectable directly or indirectly to the person with the harness including one or more adjustable straps so that the person can sleep in an upright seated position while supporting his or her head.

2. The head support as claimed in claim 1, in which the anchor section is a portion of the support which passes under the person's upper thighs so that when the person is seated on said portion it provides an anchor for the head support.

3. The head support as claimed in claim 1, in which the anchor section comprises one or more clasps on the adjustable straps, the clasps being engageable with a belt, waistband or other support on the person's body.

4. The head support as claimed in claim 1, in which the head piece is a head band.

5. A The head support as claimed in claim 1, in which the harness and head band are adjustable by a pair of straps positionable behind the person in front of the backrest of a seat on which the person is seated, whereby the harness and adjustable straps are retained out of sight, with the head band around the person's forehead only being visible when viewed front on.

6. The head support as claimed in claim 1, in which the head band may be worn under a cap so as to conceal the head band if required when viewed front on.

7. The head support as claimed in claim 1, in which the outer face of the head band may be provided with a printed message for promotional, advertising or branding purposes.

8. The head support as claimed in claim 1, in which the inner face of the head band is provided with a cushioned or soft fabric band for the comfort of the user.

9. The head support as claimed in claim 1 in which the harness and strap are adjustable by means of a plurality of buckles.

10. The head support as claimed in claim 1, in which a buckle is provided at the rear of the head band so that the size of the head band may be adjustable to suit the size of the person's head, whereby the head band may be tightened by the user to be a comfortable fit and the head band is left loose with the head band buckle being located around the base of the person's head.

11. The head support as claimed in claim 1, in which the head band, harness and adjustable straps are manufactured from a flexible strapping material.

12. The head support as claimed in claim 1, in which the strapping material is plastics webbing of approximately 25 mm in width with a portion of the headband in contact with the user being wider for comfort.

13. The head support as claimed in claim 1, in which the head band includes Velcro straps so as to be adjustable in size.

14. The head support as claimed in claim 1, which is incorporated within a coat or other garment worn by the user.

15. The head support as claimed in claim 2, in which the head piece is a head band.

16. The head support as claimed in claim 2, in which the head band includes Velcro straps so as to be adjustable in size.

17. The head support as claimed in claim 2, which is incorporated within a coat or other garment worn by the user.
